(19) United States
(12) Patent Application Publication
(10) Pub. No.: US 2017/0369794 A1
(43) Pub. Date: Dec. 28, 2017

(54) PROCESS FOR PREPARING A BASE OIL HAVING A REDUCED CLOUD POINT

(71) Applicant: SHELL OIL COMPANY, HOUSTON, TX (US)

(72) Inventors: Duurt RENKEMA, Amsterdam (NL); Johannes Leendert Willem Cornelis DEN BOESTERT, Amsterdam (NL); Eduard Philip KIEFFER, Amsterdam (NL)

(21) Appl. No.: 15/540,266

(22) PCT Filed: Dec. 30, 2015
(86) PCT No.: PCT/EP2015/081437

§ 371 Date: Jun. 28, 2017

(30) Foreign Application Priority Data
Dec. 31, 2014 (EP) 14200750.9
Jan. 6, 2015 (EP) 15150175.6

(51) Int. Cl. C10G 57/00; C10M 177/00; B01D 61/02; C10M 101/00; B01J 29/74; B01D 71/70

(52) U.S. Cl. CPC C10G 57/00; B01J 29/7469; B01D 71/70; B01D 61/022; C10M 101/00; C10M 177/00; B01D 2311/2669; C10G 2300/1022; C10G 2300/304; B01D 2319/025; B01D 2325/023; C10M 2203/003

(57) ABSTRACT

A process for preparing a base oil fraction having a reduced cloud point from a hydrocarbon feed which is derived from a Fischer-Tropsch process is provided. The process comprises:
subjecting a hydrocarbon feed which is derived from a Fischer-Tropsch process to a catalytic dewaxing treatment to obtain an at least partially isomerised product;
separating at least part of the at least partially isomerised product into one or more light hydrocarbon fractions and one or more heavy base oil fractions;
separating at least one of the heavy base oil fractions by means of a first membrane into a first permeate and a first retentate;
separating at least part of the first permeate by means of a second membrane into a second permeate and a second retentate; and
recovering the second permeate.

### FIELD OF THE INVENTION

The present invention relates to a process for preparing a base oil having a reduced cloud point.

### BACKGROUND OF THE INVENTION

It is known in the art that waxy hydrocarbon feeds, including those synthesized from gaseous components such as CO and H₂, especially Fischer-Tropsch waxes, are suitable for conversion/treatment into lubricating base oils by subjecting such waxy feeds to hydrodewaxing or hydroisomerization/catalytic (and/or solvent) dewaxing whereby long chain normal-paraffins and slightly branched paraffins are removed and/or rearranged/isomerized into more heavily branched iso-paraffins of reduced pour and cloud point. Lubricating base oils produced by the conversion/treatment of waxy hydrocarbon feeds of the type synthesized from gaseous components (i.e. from Fischer-Tropsch feedstocks), are referred to herein as Fischer-Tropsch derived base oils, or simply FT base oils.

It is known in the art to prepare so-called Fischer-Tropsch residual (or bottoms) derived lubricating base oils, referred to hereinafter as FT residual base oils. Such FT residual base oils are often FT extra heavy base oils and are obtained from a residual (or bottoms) fraction resulting from distillation of an at least partly isomerised Fischer-Tropsch feedstock. The at least partly isomerised Fischer-Tropsch feedstock may itself have been subjected to processing, such as dewaxing, before distillation. The residual base oil may be obtained directly from the residual fraction, or indirectly by processing, such as dewaxing. A residual base oil may be free from distillate, i.e. from side stream product recovered either from an atmospheric fractionation column or from a vacuum column. WO02/070627, WO2009/080681 and WO2005/047439 describe exemplary processes for making Fischer-Tropsch derived residual base oils.

FT extra heavy base oils, particularly FT residual extra heavy base oils, have found use in a number of lubricant applications on account of their excellent properties, such as their beneficial viscometric properties and purity. However, such base oils can suffer from an undesirable appearance in the form of a waxy haze at ambient temperature. Waxy haze may be inferred or measured in a number of ways. The presence of waxy haze may for instance be measured according to ASTM D4176-04 which determines whether or not a fuel or lubricant conforms with a “clear and bright” standard. Whilst ASTM D4176-04 is written for fuels, it functions too for base oils. Waxy haze in FT residual base oils, which can also adversely affect the filterability of the oils, results from the presence of long carbon chain length paraffins, which have not been sufficiently isomerised (or cracked).

The content of long carbon chain length paraffins, which stem from the waxy hydrocarbon feed, is particularly high in residual fractions from which residual base oils are derived. Since the presence of long carbon chain length paraffins also causes pour point and cloud point to be relatively high, residual fractions are typically subjected to one or more catalytic and/or solvent dewaxing steps. Such dewaxing steps are highly effective in lowering the pour point and cloud point in the resulting FT residual base oils, and under some conditions can also help to mitigate or eliminate haze, especially when combined with filtering. However, there remains a need for improved effective and efficient solutions for mitigating haze in FT base oils, especially in extra heavy base oils and residual base oils.

It is therefore an object of the invention to address the problems of waxy haze in FT base oils.

### SUMMARY OF THE INVENTION

It has now been found that waxy haze in FT extra heavy base oils can attractively reduced when these base oils are subjected to a particular separation treatment.

Accordingly, the present invention relates to a process for preparing a base oil fraction having a reduced cloud point from a hydrocarbon feed which is derived from a Fischer-Tropsch process, the process comprises the steps of:

(a) providing a hydrocarbon feed which is derived from a Fischer-Tropsch process;
(b) subjecting the hydrocarbon feed of step (a) to a catalytic dewaxing treatment to obtain an at least partially isomerised product;
(c) separating at least part of the at least partially isomerised product as obtained in step (b) into one or more light hydrocarbon fractions and one or more heavy base oil fractions;
(d) separating at least one of the heavy base oil fractions as obtained in step (c) by means of a first membrane into a first permeate which comprises a base oil having a reduced cloud point and a first retentate which comprises a base oil containing haze compounds, wherein the membrane separation is carried out at a temperature in the range of from the pour point of the base oil and up to 120° C. and a pressure in the range of from 5-60 bar; and
(e) separating at least part of the first permeate as obtained in step (d) by means of a second membrane into a second permeate which comprises a base oil having a further reduced cloud point and a second retentate which comprises a base oil containing haze compounds, wherein the membrane separation is carried out at a temperature in the range of from the pour point of the base oil and up to 120° C. and a pressure in the range of from 5-60 bar; and
(f) recovering the second permeate as obtained in step (e).

In accordance with the present invention haze free heavy base oils can be prepared which need to be dewaxed to a lesser extent. In addition, the base oils prepared in accordance with the present invention will stay haze free also after long storage times.

### DETAILED DESCRIPTION OF THE INVENTION

The hydrocarbon feed provided in step (a) is a hydrocarbon feed derived from a Fischer-Tropsch process. Preferably, the hydrocarbon oil is an extra heavy base oil component derived from a Fischer-Tropsch process. The Fischer-Tropsch derived extra heavy base oil is a Fischer-Tropsch derived hydrocarbons base oil product comprising saturated paraffin molecules. On account of being an extra heavy oil, it is typically prone to the formation of waxy haze. The Fischer-Tropsch extra heavy base oil may typically comprise at least 95 wt % saturated hydrocarbon molecules. Preferably, the Fischer-Tropsch extra heavy base oil is prepared from a Fischer-Tropsch wax and comprises more than 98 wt % of saturated hydrocarbons. Preferably, at least 85 wt %, more preferably at least 90 wt %, yet more preferably at least 95 wt %, and most preferably at least 98 wt % of these saturated hydrocarbon molecules are isoparaffinic.

Naphthenic compounds (paraffinic cyclic hydrocarbons) are preferably present in an amount of no more than 15 wt %, more preferably less than 10 wt %.

The Fischer-Tropsch extra heavy base oil to be used in accordance with the present invention suitably contains hydrocarbon molecules having consecutive numbers of carbon atoms, such that it comprises a continuous series of consecutive iso-paraffins, i.e. iso-paraffins having n, n+1, n+2, n+3 and n+4, etc. carbon atoms (where n is number of carbon atoms of the lightest iso-paraffin molecule in the extra heavy base oil to be used). This series is a consequence of the Fischer-Tropsch hydrocarbon synthesis reaction from which the extra heavy base oil derives, following isomerisation of the wax feed. The Fischer-Tropsch extra heavy base oil is typically a liquid at the temperature and pressure conditions of use and typically, although not always, under standard ambient temperature and pressure.

The Fischer-Tropsch derived hydrocarbon feed will be prone to the formation of haze in the sense that it fails the ‘clear and bright’ standard (ASTM D4176-04) at standard conditions. The extent of waxy haze in Fischer-Tropsch extra heavy base oils tends to increase with high viscosity, high boiling points, a high proportion of C30+ molecules, a high cloud point, a high pour point, a relatively low degree of isomerisation, derivation of the oil from residual fractions rather than distillates, derivation of the oil from particularly heavy waxy hydrocarbon feeds, and catalytic dewaxing as opposed to solvent dewaxing. The persistence of haze, particularly in the context of dewaxing, may also be linked to these factors. Fischer-Tropsch extra heavy base oils in which waxy haze formation is pronounced and/or persistent benefit particularly from the invention and are hence preferred as effective but economical components for use in the present invention.

The kinematic viscosity at 100° C. according to ASTM D445 (VK 100) of the FT extra heavy base oil may typically be at least 15 mm²/s. Preferably, its VK 100 may be at least 17 mm²/s, more preferably at least 18 mm²/s, yet more preferably at least 19 mm²/s, again more preferably at least 22 mm²/s, and yet again more preferably at least 24 mm²/s. In some embodiments, the VK100 may be at most 100 mm²/s, or even at most 80 mm²/s or at most 50 mm²/s, or even at most 35 mm²/s.

The viscosity index of the Fischer-Tropsch derived extra heavy base oil is preferably greater than 140.

The hydrocarbon feed may have a lower boiling point (T5 or 5% off) of at least 300° C. More preferably, its lower boiling point (T5 or 5% off) may be at least 450° C., yet more preferably at least 470° C. An upper boiling point (T80 or 80% off) of the FT extra heavy base oil may be at least 600° C. More preferably, its upper boiling point (T80) may be at least 650° C., yet more preferably at least 700° C. The lower and upper boiling point values referred to herein are nominal and refer to the T5 and T80 boiling temperatures obtained by gas chromatograph simulated distillation (GCD) according to ASTM D-7169. Any boiling range distributions of samples are measured herein according to ASTM D-7169. Since Fischer-Tropsch derived hydrocarbons comprise a mixture of varying molecular weight components having a wide boiling range, this disclosure refers to recovery points of boiling ranges. For example, a 10 wt % recovery point refers to that temperature at which 10 wt % of the hydrocarbons present within that cut will vaporise at atmospheric pressure, and could thus be

recovered. Similarly, a 90 wt % recovery point refers to the
temperature at which 90 wt % of the hydrocarbons present will vaporise at atmospheric pressure. Unless otherwise specified, when referring to a boiling range
distribution, the boiling range between the 10 wt % and 90 wt % recovery boiling points is referred to in this specification.

The Fischer-Tropsch derived hydrocarbon feed preferably contains at least 95 wt % C30+ hydrocarbon molecules. More preferably, the hydrocarbon feed contains at least 75 wt % of C35+ hydrocarbon molecules.

In the context of the present application the term “Cloud point” refers to the temperature at which a sample begins to develop a haze, as determined according to ASTM D-5773. The hydrocarbon feed suitably has a cloud point in the range of from +75° C. to +30° C. Preferably, the hydrocarbon feed has a cloud point in the range of from +70° C. and +40° C., most preferably in the range of from +65° C. and +45° C.

The term “Pour point” refers to the temperature at which a sample will begin to flow under carefully controlled conditions. The pour points referred to herein were determined according to ASTM D-97-93. The Fischer-Tropsch derived hydrocarbon feed suitably has a pour point of +20° C. or lower, preferably of 0° C. or −25° C. or −40° C. or even −60° C. or lower.

The hydrocarbon feed is typically dewaxed before it is subjected to the process of the present invention. It is a major advantage of the present invention that the hydrocarbon feed only needs to be dewaxed relatively mildly before it is subjected to the present invention.

The hydrocarbon feed suitably has a viscosity index (ASTM D-2270) of between 120 and 180. It preferably contains no or very little sulphur and nitrogen containing compounds.

The Fischer-Tropsch derived hydrocarbon feed is preferably a Fischer-Tropsch residual base oil, i.e. obtained from a residual or high vacuum bottoms fraction from the hydrocarbons produced during a Fischer-Tropsch synthesis reaction.

More preferably, this fraction is a distillation residue comprising the highest molecular weight compounds still present in the product after a hydroisomerisation step. The 10 wt % recovery boiling point of said fraction is preferably above 370° C., more preferably above 400° C. and most preferably above 480° C. for certain embodiments of the present invention.

The density of the FT extra heavy base oil component, as measured at 15° C. by the standard test method IP 365/97, is suitably from about 700 to 1100 kg/m³, preferably from about 825 to 855 kg/m³.

The hydrocarbon feed may contain a mixture of two or more FT extra heavy base oils.

In general, the hydrocarbon feed provided in step (a) for use in the present invention may be prepared by any suitable Fischer-Tropsch process. Preferably, the hydrocarbon feed is a heavy bottom fraction obtained from a Fischer-Tropsch derived wax or waxy raffinate feed. Prior to step (b), the hydrocarbon feed as provided in step (a) can be subjected to a hydrocracking treatment in a step (i), followed by a separation step (ii) in which at least part of the hydrocracked product as obtained in step (a) (i) is separated into a first fraction having a boiling point below 380° C. and a second fraction having a boiling point which is higher than 300° C., wherein the second fraction preferably comprises at least 10 wt % of compounds boiling above 540° C. The first fraction so obtained is then subjected to step (b).

Accordingly, the present invention also provides a process for preparing a base oil fraction having a reduced cloud point from a hydrocarbon feed which is derived from a Fischer-Tropsch process, the process comprises the steps of:

(a) providing a hydrocarbon feed which is derived from a Fischer-Tropsch process;
(a) (i) hydrocracking the hydrocarbon feed provided in step (a) to obtain a hydrocracked product;
(a) (ii) separating at least part of the hydrocracked product as obtained in step (a)(i) into a first fraction having a boiling point below 380° C. and a second fraction having a boiling and a second fraction having a boiling point which is higher than 300° C.;
(a)(iii) optionally separating at least part of the second fraction having a boiling point higher than 300° C. into a third fraction having a boiling point below 600° C. and a fourth fraction having a boiling point which is higher than 450° C.,
(b) subjecting at least part of the second fraction having a boiling point higher than 300° C. as obtained in step a(ii) and/or at least part of the fourth fraction having a boiling point which is higher than 450° C. as obtained in step (a)(iii) to a catalytic dewaxing treatment to obtain an at least partially isomerised product;
(c) separating at least part of the at least partially isomerised product as obtained in step (b) into one or more light hydrocarbon fractions and one or more heavy base oil fractions;
(d) separating at least one of the heavy base oil fractions as obtained in step (c) by means of a first membrane into a first permeate which comprises a base oil having a reduced cloud point and a first retentate which comprises a base oil containing haze compounds, wherein the membrane separation is carried out at a temperature in the range of from the pour point of the base oil and up to 120° C. and a pressure in the range of from 5-60 bar; and
(e) separating at least part of the first permeate as obtained in step (d) by means of a second membrane into a second permeate which comprises a base oil having a further reduced cloud point and a second retentate which comprises a base oil containing haze compounds, wherein the membrane separation is carried out at a temperature in the range of from the pour point of the base oil and up to 120° C. and a pressure in the range of from 5-60 bar; and
(f) recovering the second permeate as obtained in step (e).

When in step (b) at least part of the second fraction having a boiling point higher than 300° C. and at least part of the fourth fraction having a boiling point which is higher than 450° C. are subjected to a catalytic dewaxing treatment, the catalytic dewaxing treatment of each respective fraction can be carried out in a separate reaction vessel or both fractions can suitably be subjected to the catalytic dewaxing treatment in one and the same reaction vessel.

The hydrocracking in step (a)(i) is performed at elevated temperature and pressure. The temperatures typically will be in the range of from 175 to 380° C., preferably higher than 250° C. and more preferably from 300 to 370° C. The pressure will typically be in the range of from 10 to 250 bara and preferably between 20 and 80 bara. Hydrogen may be supplied at a gas hourly space velocity of from 100 to 10000 Nl/l/hr, preferably from 500 to 5000 Nl/l/hr. The hydrocarbon feed may be provided at a weight hourly space velocity of from 0.1 to 5 kg/l/hr, preferably higher than 0.5 kg/l/hr and more preferably lower than 2 kg/l/hr. The ratio of hydrogen to hydrocarbon feed may range from 100 to 5000 Nl/kg and is preferably from 250 to 2500 Nl/kg. In step (a)(i), one or more catalysts can be used, and one or more beds of catalysts can be employed. The one or more catalysts in step (a) (i) may consist of any one or more metals or compounds thereof having hydrocracking properties. Preferably, the one or more catalysts in step (a)(i) comprise one or more noble metals, preferably platinum and/or palladium, more preferably platinum.

In another attractive embodiment of the present invention, prior to step (b) the hydrocarbon feed as provided in step (a) is subjected to a thermal conversion treatment and a hydrogenation treatment instead of a hydrocracking treatment.

Accordingly, the present invention also relates to a process for preparing a base oil fraction having a reduced cloud point from a hydrocarbon feed which is derived from a Fischer-Tropsch process, the process comprises the steps of:

(a) providing a hydrocarbon feed which is derived from a Fischer-Tropsch process;
(a) (i) subjecting the hydrocarbon feed as provided in step (a) to a thermal conversion step to obtain a converted hydrocarbon stream comprising paraffins and olefins;
(a) (ii) separating at least part of the converted hydrocarbon stream as obtained in step (b) into a first fraction having a boiling point below 380° C. and a second fraction having a boiling point which is higher than 300° C.;
(a) (iii) optionally separating at least part of the second fraction having a boiling point higher than 300° C. into a third fraction having a boiling point below 600° C. and a fourth fraction having a boiling point which is higher than 450° C.
(a) (iv) hydrogenating at least part of the second fraction having a boiling point higher than 300° C. as obtained in step (a) (ii) and/or at least part of the fourth fraction having a boiling point which is higher than 450° C. as obtained in step (a) (iii) to obtain a hydrogenated second fraction having a boiling point higher than 300° C. and/or a hydrogenated fourth fraction having a boiling point which is higher than 450° C.;
(b) subjecting at least part of the hydrogenated fraction having a boiling point higher than 300° C. and/or at least part of the hydrogenated fourth fraction having a boiling point which is higher than 450° C. as obtained in step (a) (iv) to a catalytic dewaxing treatment to obtain an at least partially isomerised product;
(c) separating at least part of the at least partially isomerised product as obtained in step (b) into one or more light hydrocarbon fractions and one or more heavy base oil fractions;
(d) separating at least one of the heavy base oil fractions as obtained in step (c) by means of a first membrane into a first permeate which comprises a base oil having a reduced cloud point and a first retentate which comprises a base oil containing haze compounds; and
(e) separating at least part of the first permeate as obtained in step (d) by means of a second membrane into a second permeate which comprises a base oil having a further reduced cloud point and a second retentate which comprises a base oil containing haze compounds; and
(f) recovering the second permeate as obtained in step (e).

When in step (a)(iv) at least part of the second fraction having a boiling point higher than 300° C. and at least part of the fourth fraction having a boiling point which is higher than 450° C. are hydrogenated to obtain a hydrogenated second fraction having a boiling point above 300° C. and a hydrogenated fourth fraction having a boiling point which is higher than 450° C., the hydrogenation of each respective fraction can be carried out in a separate reaction vessel or both fractions can suitably be subjected to the hydrogenation in one and the same reaction vessel.

When in step (b) at least part of the hydrogenated second fraction having a boiling point higher than 300° C. and at least part of the hydrogenated fourth fraction having a boiling point which is higher than 450° C. are subjected to a catalytic dewaxing treatment, the catalytic dewaxing treatment of each fraction can be carried out in a separate reaction vessel or both fractions can suitably be subjected to the catalytic dewaxing treatment in one and the same reaction vessel.

In step (a) (iv), at least part of the second fraction having a boiling point higher than below 300° C. and/or at least part of the fourth fraction having a boiling point which is higher than 450 is hydrogenated to obtain a hydrogenated second fraction having a boiling point higher than 300° C. and/or a hydrogenated fourth fraction having a boiling point which is higher than 450° C. Suitably, either the entire second fraction as obtained in step (a)(ii) is hydrogenated in step (a) (iv) to obtain a hydrogenated second fraction having a boiling point higher than 300° C. and/or the entire fourth fraction as obtained in step (a) (iii) is hydrogenated in step (a) (iv) to obtain a hydrogenated fourth fraction having a boiling point higher than 450° C. Step (a) (iv) is suitably performed in the presence of hydrogen and a hydrogenation catalyst, which catalyst can be chosen from those known to one skilled in the art as being suitable for this reaction. Catalysts for use in step (a) (iii) typically are amorphous catalysts comprising a hydrogenation functionality and an amorphous support. Preferred supports are refractory metal oxide carriers. Suitable carrier materials include silica, alumina, zirconia, titania and mixtures thereof. Preferred carrier materials for inclusion in the catalyst for use in the process of this invention are silica and alumina. Preferred hydrogenation functionality catalysts include Group VIII non-noble metals. A particularly preferred catalyst comprises nickel supported on an alumina carrier. The catalyst may comprise the hydrogenation active component in an amount of from 0.5 to 50 parts by weight, preferably from 2 to 30 parts by weight, per 100 parts by weight of carrier material. The catalyst may also comprise a binder to enhance the strength of the catalyst. The binder will be non-acidic. Examples are clays, alumina and other binders known to one skilled in the art. Preferably, the catalyst is substantially amorphous, meaning that no crystalline phases are present in the catalyst. In step (d), the second fraction having a boiling point higher than 300° C. as obtained in step (a)(ii) is contacted with hydrogen in the presence of the catalyst at elevated temperature and pressure and/or the fourth fraction having a boiling point higher than 450° C. as obtained in step (a) (iii) is contacted with hydrogen in the presence of the catalyst at elevated temperature and pressure. The temperatures typically will be in the range of from 180-280° C., preferably higher than 190° C. and more preferably in the range of from 200-240° C. The pressure will typically be in the range of from 10-70 bar and preferably between 40-60 bar. The second fraction having a boiling point higher than 300° C. as obtained in step (a) (ii) and/or the fourth fraction having a boiling point higher than 450° C. as obtained in step (a)(iii) may be provided at a weight hourly space velocity of from 0.1-5 kg/l/hr, preferably higher than 0.5 kg/l/hr and more preferably lower than 2 kg/l/hr. The ratio of hydrogen to hydrocarbon feed may range from 100-5000 Nl/kg and is preferably from 250-2500 Nl/kg. The hydrogenation carried out in step (a)(iv) at the process conditions specified above, the olefins and oxygenates present in the light Fischer Tropsch product fraction are hydrogenated almost to extinction (olefins removal of more than 99% and oxygenates removal of more than 97%).

In step (b), the hydrocarbon feed as provided in step (a), the hydrocracked product as obtained in step (a) (i) or the hydrogenated fraction as obtained in step (a) (iv) is subjected to a dewaxing step to obtain an at least partially isomerised product. The catalytic dewaxing process in step (b) may be any process wherein in the presence of a catalyst and hydrogen the pour point of the base oil precursor fraction is reduced. Suitable dewaxing catalysts are heterogeneous catalysts comprising a molecular sieve and optionally in combination with a metal having a hydrogenation function, such as the Group VIII metals. Molecular sieves, and more suitably intermediate pore size zeolites, have shown a good catalytic ability to reduce the pour point of the base oil precursor fraction under catalytic dewaxing conditions. Preferably, the intermediate pore size zeolites have a pore diameter of between 0.35 and 0.8 nm. Suitable intermediate pore size zeolites are mordenite, ZSM-5, ZSM-12, ZSM-22, ZSM-23, SSZ-32, ZSM-35, ZSM-48 and MCM-68. Another preferred group of molecular sieves are the silica-aluminaphosphate (SAPO) materials of which SAPO-Il is most preferred as for example described in U.S. Pat. No. 4,859,311. ZSM-5 may optionally be used in its HZSM-5 form in the absence of any Group VIII metal. The other molecular sieves are preferably used in combination with an added Group VIII metal. Suitable Group VIII metals are nickel, cobalt, platinum and palladium. Examples of possible combinations are Pt/ZSM-35, Ni/ZSM-5, Pt/ZSM-23, Pd/ZSM-23, Pt/ZSM-48 and Pt/SAPO-11. Further details and examples of suitable molecular sieves and dewaxing conditions are for example described in WO-A-9718278, U.S. Pat. No. 4,343,692, U.S. Pat. No. 5,053,373, U.S. Pat. No. 5,252,527, U.S. Pat. No. 4,574,043, WO-A-0014179 and EP-A-1029029. The dewaxing catalyst suitably also comprises a binder. The binder can be a synthetic or naturally occurring (inorganic) substance, for example clay, silica and/or metal oxides. Natural occurring clays are for example of the montmorillonite and kaolin families. The binder is preferably a porous binder material, for example a refractory oxide of which examples are: alumina, silica-alumina, silica-magnesia, silica-zirconia, silica-thoria, silica-beryllia, silica-titania as well as ternary compositions for example silica-alumina-thoria, silica-alumina-zirconia, silica-alumina-magnesia and silica-magnesia-zirconia. More preferably a low acidity refractory oxide binder material, which is essentially free of alumina, is used. Examples of these binder materials are silica, zirconia, titanium dioxide, germanium dioxide, boria and mixtures of two or more of these of which examples are listed above. The most preferred binder is silica.

A preferred class of dewaxing catalysts comprise intermediate pore size zeolite crystallites as described above and a low acidity refractory oxide binder material which is essentially free of alumina as described above, wherein the alumina content of the aluminosilicate zeolite crystallites and especially the surface of said zeolite crystallites has been modified by subjecting the aluminosilicate zeolite crystallites to a surface dealumination treatment. Steaming is a possible method of reducing the alumina content of the crystallites. A preferred dealumination treatment is by contacting an extrudate of the binder and the zeolite with an aqueous solution of a fluorosilicate salt as described in for example U.S. Pat. No. 5,157,191 or WO-A-0029511. This method is believed to selectively dealuminate the surface of the zeolite crystallites. Examples of suitable dewaxing catalysts as described above are silica bound and dealuminated Pt/ZSM-5, silica bound and dealuminated Pt/ZSM-23, silica bound and dealuminated Pt/ZSM-12, silica bound and dealuminated Pt/ZSM-22, as for example described in WO-A-0029511 and EP-B-832171.

More preferably the molecular sieve is a MTW, MTT or TON type molecular sieve, of which examples are described above, the Group VIII metal is platinum or palladium and the binder is silica.

Preferably, the catalytic dewaxing in step (b) is performed in the presence of a catalyst as described above wherein the zeolite has at least one channel with pores formed by 12-member rings containing 12 oxygen atoms. Preferred zeolites having

12-member rings are of the MOR type, MTW type, FAU type, or of the BEA type (according to the framework type code). Preferably, a MTW type, for example ZSM-12, zeolite is used. A preferred MTW type zeolite containing catalyst also comprises as a platinum or palladium metal as Group VIII metal and a silica binder. More preferably the catalyst is a silica bound AHS treated Pt/ZSM-12 containing catalyst as described above. These 12-member ring type zeolite based catalysts are preferred because they have been found to be suitable to convert waxy paraffinic compounds to less waxy iso-paraffinic compounds.

Catalytic dewaxing conditions are known in the art and typically involve operating temperatures in the range of from 200-500° C., suitably from 250-400° C., hydrogen pressures in the range of from 10-200 bara, preferably from 40-70 bara, weight hourly space velocities (WHSV) in the range of from 0.1-10 kg of oil per litre of catalyst per hour (kg/l/hr), suitably from 0.2-5 kg/l/hr, more suitably from 0.5-3 kg/l/hr and hydrogen to oil ratios in the range of from 100-2,000 litres of hydrogen per kilogram of oil.

In step (c), at least part of the at least partially isomerised product as obtained in step (b) is separated into one or more light hydrocarbon fractions and one or more heavy base oil fractions. Suitably, the entire at least partially isomerised product as obtained in step (b) is separated in step (c) into one or more light hydrocarbon fractions and one or more heavy base oil fractions. Suitably, the one or more light carbon fractions as obtained in step (c) have a boiling point in the range of from 40-400° C., preferably in the range of from 60-380° C. Suitably, the one or more heavy base oil fractions as obtained in step (c) have a boiling point in the range of from 340-750° C., preferably in the range of from 380-750° C. The separation in step (c) is suitably carried out by means of distillation. The separation in step (c) may be performed by performing a distillation at atmospheric pressure or under vacuum conditions. The separation in step (c) may also include a first atmospheric distillation followed by a further distillation at vacuum distillation conditions.

In steps (d), at least one of the heavy base oil fractions as obtained in step (c) is separated by means of a first membrane into a first permeate which comprises a base oil having a reduced cloud point and a first retentate which comprises a base oil containing haze compounds.

Typical examples of haze compounds are all normal paraffins in the heavy base oil boiling range, multiple methyl branched paraffins with carbon number in excess of C25 and highly methyl branched paraffins with carbon number in excess of C55.

Preferably, all the heavy base oil fractions as obtained in step (c) are subjected to step (d).

The membrane is suitably a so-called nano-filtration or a reserve osmosis type membrane. The membrane may be of a ceramic type or a polymeric type. Suitable ceramic membranes are ceramic NF membrane types, having a Molecular Weight Cut Off (MWCO) of less than 2000 Da, preferably less than 1000 Da and even more preferred less than 500 Da. The advantage of said ceramic type membranes is that they do not have to swell in order to work under optimal conditions. This is especially advantageous because the hydrocarbon feedstock does not contain substantial amounts of aromatic compounds. Examples of ceramic types are mesoporous titania, mesoporous gamma-alumina, mesoporous zirconia and mesoporous silica. Also polymeric membranes can be used. Polymeric membranes suitably comprise of a top layer made of a dense membrane and a base layer (support) made of a porous membrane. The membrane is suitably so arranged that the permeate flows first through the dense membrane top layer and then through the base layer, so that the pressure difference over the membrane pushes the top layer onto the base layer. The dense membrane layer is the actual membrane which separates the contaminants from the hydrocarbon mixture. The dense polymeric membrane, which is well known to one skilled in the art, has properties such that the hydrocarbon mixture passes said membrane by dissolving in and diffusing through its structure. Preferably the dense membrane layer has a so-called cross-linked structure as for example described in WO-A-9627430. The thickness of the dense membrane layer is preferably as thin as possible. Suitably the thickness is between 0.5 and 15 micrometer, preferably between 1 and 5 micrometer. It is believed that the haze compounds are not capable to dissolve as readily in said dense membrane because of their more complex structure and high molecular weight.

Suitable dense membranes can be made from a polysiloxane, in particular from poly (di-methyl siloxane) (PDMS), poly octyl-methyl siloxane (POMS), poly imide, poly aramide and poly tri-methyl silyl propyne (PTMSP). The porous base layer provides mechanical strength to the membrane.

Suitable porous base layers are PolyAcryloNitrile (PAN), PolyAmideImide+TiO2 (PAI), PolyEtherImide (PEI), PolyVinylideneDiFluoride (PVDF), and porous PolyTetraFluoroEthylene (PTFE), polyaramide. A suitable combination is a POMS-PAN combination.

The membrane separation in step (d) is suitably performed in a membrane unit, which comprises of one or more membrane modules. Examples of suitable modules are typically expressed in how the membrane is positioned in such a module. Examples of these modules are the spirally wound, plate and frame, hollow fibres and tubular modules. Preferred module configurations are spirally wound and plate and frame. Spirally wound is most preferred when a dense membrane is used. These membrane modules are well known to the skilled person as for example described in Encyclopedia of Chemical Engineering, 4th Ed., 1995, John Wiley & Sons Inc., VoI 16, pages 158-164. Examples of spirally wound modules are described in for example, U.S. Pat. No. 5,102,551, U.S. Pat. No. 5,093,002, U.S. Pat. No. 5,275,726, U.S. Pat. No. 5,458,774 and U.S. Pat. No. 5,150,118.

During separation in step (d) the pressure difference across the membrane is typically between 5 and 60 bar and more preferably between 10 and 30 bar. The membrane separation in step (d) is suitably carried out at a temperature in the range of from the pour point of the base oil feedstock and up to 120° C., in particular 10 to 100° C., and suitably in the range of 15-85° C. The feed flux over the membrane is preferably between 100 and 4000 kg/m2 membrane area per day.

Preferably the membrane separation in step (e) is performed as a continuous process wherein feed is passed over the membrane due to a pressure difference such to obtain a haze free permeate. Part of the feed, the retentate comprising the haze compounds, will not pass the membrane. The retentate will be discharged from the unit. The mass ratio between permeate and retentate is suitably between 1 and 20 and suitably between 5 and 10. Preferably the local velocities of the feed at the retentate side of the membrane are such that a turbulent flow regime exists. This will facilitate that the haze molecules remain in the retentate or are re-dissolved from the membrane into the retentate.

Preferably the local velocities may be increased deliberately by for example vibration or rotation of the membrane. Examples of such processes are described in EP-A-1424124 and U.S. Pat. No. 5,725,767.

During separation in step (e) the pressure difference across the membrane is typically between 5 and 60 bar and more preferably between 10 and 30 bar. The membrane separation in step (e) is suitably carried out at a temperature in the range of from the pour point of the base oil feedstock and up to 120° C., in particular 10 to 100° C., and suitably in the range of 15-85° C. The feed flux over the membrane is preferably between 100 and 4000 kg/m2 membrane area per day.

In order to further avoid haze compounds from passing the membrane it may be advantageous to regularly flush the membranes at their retentate side with a solvent. Suitable solvents may be the paraffinic solvents or base oils, such as the permeate itself, which are produced in a Fischer-Tropsch process. Such flushing operations are common in membrane process operations and are referred to as conventional cleaning in place (CIP) operations. In such operations a membrane unit may be cleaned while other parallel oriented membrane units continue to perform the desired separation process. It may be preferred to also substantially lower the pressure difference over the membrane at regular time intervals. During the time interval at which the pressure difference is lowered the pressure difference is preferably between 0 and 5 bar, more preferably below 1 bar and most preferably 0 bar. Because of this reduction in pressure difference haze compounds which may have attached to the membrane surface and which cause the feed flux to decrease are believed to re-entrain in the flow of retentate. After applying the original pressure difference it is observed that the feed flux is restored to its original level.

The pressure difference can be suitably achieved by operating pumping means upstream and/or downstream the membranes. In a preferred embodiment of the invention the lowering of the pressure at regular intervals is achieved by stopping the flow of contaminated hydrocarbon mixture to the membrane. This can be achieved by stopping the pumping means. Stopping and activating pumping means is not always desirable. In a situation wherein the pressure difference is achieved by at least an upstream pump it can be desirable to recycle the hydrocarbon mixture from a position between the operating pump and the membrane to a position upstream the operating pump without stopping the pump. In this manner the flow to the membrane can be temporarily discontinued while the pump can remain in its operating mode. Alternatively one upstream pumping means can provide a hydrocarbon mixture feed to more than one parallel operating membrane separator or one or more parallel operating groups of parallel operating membrane separators, each separator or group of separators provided with an individual valve to interrupt the feed to said separator or group of separators. By closing and opening in a sequential manner the separate valves the (groups of) membrane separators can be operated according to the process of the present invention without having to stop the upstream pump.

More preferably, one can also achieve the temporary-reduction in pressure drop by closing a valve in the conduit through which permeate is discharged from the membrane unit. In this manner the upstream pump does not have to be switched of. Temporarily all feed will then end up as retentate.

One skilled in the art can easily determine the optimal time periods of continuous separation and the time periods at which the pressure difference is substantially lower. Maximising the average feed flux over the membrane separator will drive such determination. With average feed flux is here meant the average feed flux over both separation and intermediate time periods. Thus it is desirable to minimize the time periods at which the pressure is substantially lower and maximizing the time period at which separation takes place. The feed flux will decrease in the separation intervals and suitably when the feed flux becomes less than 75-99% of its maximum value the separation interval is stopped. Suitably between 5 and 480 minutes of continuous separation across the membrane alternates with time periods of between 1 and 60 minutes, preferably below 30 minutes and more preferably below 10 minutes and most preferably below 6 minutes of at which the pressure difference is substantially lowered.

The first permeate as obtained in step (d) has suitably a cloud point in the range of from 40-0° C., preferably in the range of from 30-5° C., and more preferably in the range of from 25-10° C.

In step (e), at least part of the first permeate as obtained in step (d) is separated by means of a second membrane into a second permeate which comprises a base oil having a further reduced cloud point and a second retentate which comprises a base oil containing haze compounds.

The second permeate comprises a base oil which has a further reduced cloud point when compared with the first permeate as obtained in step (d).

The second permeate as obtained in step (e) has suitably a cloud point of less than 30° C., preferably in the range of from −2-25° C., and more preferably in the range of from −5-20° C.

The second membrane can be any of the membranes as described hereinbefore. Preferably, the first membrane as used in step (d) is similar to the second membrane as used in step (e).

The separation in step (e) can be carried out in a similar way as described hereinbefore in respect of step (d).

It will be appreciated that steps (d) and (e) are carried out in series, whereby the first permeate as obtained in step (d) is used as the feed for the second separation in step (e).

Preferably, the entire first permeate as obtained in step (d) is subjected to step (e).

Suitably, at least part of the first retentate as obtained in step (d) is recycled to step (b). Preferably, the entire first retentate as obtained in step (d) is recycled to step (b).

Suitably, at least part of the second retentate as obtained in step (e) is recycled to step (b). Preferably, the entire second retentate as obtained in step (d) is recycled to step (b).

In step (f), the second permeate is recovered.

The present invention will now be further illustrated by the following non-limiting examples.

### EXAMPLES

### Example 1

A Fischer-Tropsch product (12.3 wt % naphtha, 13.7 wt % gas oil, 21.8 wt % vacuum gas oil, 52.2 wt % residue; and having a pour point of 105° C.) was subjected to a hydrocracking/hydroisomerisation conversion step. The hydrocracking process was carried out at 80 barg, a temperature of 346° C., a WHSV of 1.0 kg/l/hr, and a hydrogen gas to oil ratio of 750 Nl/kg. At these conditions a 370° C. conversion was reached of 40%. The hydrocracking catalyst comprised platinum and a silica-alumina carrier. The hydrocracker effluent was separated by distillation at atmospheric conditions to obtain a fraction boiling below 360° C. and a bottoms residual fraction boiling above 360° C. The fraction boiling above 360° C. was further distilled in a vacuum column at an atmospheric cut point of about 540° C. The residual fraction from the vacuum column was further subjected to a catalytic dewaxing step which was carried out at a temperature of 331° C., a pressure of 40 barg, a WHSV of 0.5 kg/l/hr, and a hydrogen gas to oil ratio of 500 Nl/kg. In the catalytic dewaxing step a catalyst was used comprising platinum and a MTW molecular sieve. The hydrocarbon effluent of the catalytic dewaxing unit was distilled under vacuum conditions to yield a heavy base oil residual product with a T5% of around 480° C. The kinematic viscosity of the base oil was measured to be 25 centistokes (or mm2/s) at 100° C. The yield of heavy base oil on intake to the catalytic dewaxing unit was 52 percent by weight. The heavy base oil had a hazy appearance at room temperature.

This catalytically dewaxed heavy base oil was fed to the 1^{st} membrane unit operated at 85° C. and 15 barg, that was charged with a POMS siloxane membrane. The membrane unit was run at a permeate recovery 70% by weight on membrane unit intake. The base oil product Cloud Point reduced to 19° C. The permeate fraction of the 1^{st} membrane unit was processed over a 2^{nd} membrane unit operating at the same conditions as the fist one. This membrane unit was run at a permeate recovery 84% by weight on membrane unit intake. The permeate base oil product Cloud Point further reduced to −10° C. The appearance was bright and clear at 0° C. Kinematic viscosity of the heavy base oil was 19 centistokes. Yield of heavy base oil basis catalytic dewaxing unit intake was 31% by weight. The various experimental data are shown in Table 1.

### Example 2

In a further example according to the invention, the catalytic dewaxing severity was increased. The catalytic dewaxing unit which was carried out at a temperature of 336° C., a pressure of 40 barg, a WHSV of 0.5 kg/l/hr, and a hydrogen gas to oil ratio of 500 Nl/kg. The same catalyst was used as in Example 1. The hydrocarbon effluent of the catalytic dewaxing unit was distilled to yield a heavy base oil residual product with a T5% of around 480° C. The kinematic viscosity of the base oil was measured to be 23 centistokes (or mm2/s) at 100° C. The yield of heavy base oil on intake to the catalytic dewaxing unit was 40 percent by weight. The heavy base oil had a hazy appearance at room temperature.

The catalytically dewaxed heavy base oil was fed to the 1^{st} membrane unit operated at 85° C. and 15 barg, that was charged with a POMS siloxane membrane. The base oil product Cloud Point reduced to 8° C. The permeate fraction of the 1^{st} membrane unit was processed over a 2^{nd} membrane unit operating at the same conditions as the first one. The permeate base oil product Cloud Point further reduced to −22° C. The appearance was bright and clear at 0° C. Kinematic viscosity of the heavy base oil was 17 centistokes. Yield of heavy base oil basis catalytic dewaxing unit intake was 28% by weight. The various experimental data are shown in Table 1.

### Example 3

In a further example the catalytic dewaxing severity was reduced. The catalytic dewaxing unit which was carried out at a temperature of 319° C., a pressure of 40 barg, a WHSV of 0.5 kg/l/hr, and a hydrogen gas to oil ratio of 500 Nl/kg. The same catalyst was used as in Examples 1 and 2. The hydrocarbon effluent of the catalytic dewaxing unit was distilled to yield a heavy base oil residual product with a T5% of around 480° C. The kinematic viscosity of the base oil was measured to be 31 centistokes (or mm2/s) at 100° C. The yield of heavy base oil on intake to the catalytic dewaxing unit was 89 percent by weight. The heavy base oil had a hazy appearance at room temperature. The cloud point of the catalytically dewaxed hazy heavy base oil was 82° C.

The catalytically dewaxed heavy base oil was fed to the 1^{st} membrane unit operated at 85° C. and 15 barg, that was charged with a POMS siloxane membrane. The base oil product Cloud Point reduced to 52° C. The permeate fraction of the 1^{st} membrane unit was processed over a 2^{nd} membrane unit operating at the same conditions as the first one. The permeate base oil product Cloud Point further reduced to 22° C. The appearance of the heavy base oil permeate was still hazy. Kinematic viscosity of the heavy base oil was high at 25 centistokes. Yield of heavy base oil basis catalytic dewaxing unit intake was 26% by weight. The various experimental data are shown in Table 1.

This example demonstrates that significant catalytic dewaxing is required to make a bright and clear heavy base oil when applying the two membrane units in series option for dehazing work.

### Example 4

In a further example the catalytic dewaxing severity was increased to allow clear and bright heavy base oils to be produced in a single membrane separation step. The catalytic dewaxing unit which was carried out at a temperature of 340° C., a pressure of 40 barg, a WHSV of 0.5 kg/l/hr, and a hydrogen gas to oil ratio of 500 Nl/kg. The same catalyst was used as in Examples 1 and 2. The hydrocarbon effluent of the catalytic dewaxing unit was distilled to yield a heavy base oil residual product with a T5% of around 480° C. The kinematic viscosity of the base oil was measured to be 21 centistokes (or mm2/s) at 100° C. The yield of heavy base oil on intake to the catalytic dewaxing unit was 28 percent by weight. The heavy base oil had a hazy appearance at room temperature. The cloud point of the catalytically dewaxed hazy heavy base oil was 28° C.

The catalytically dewaxed heavy base oil was fed to a membrane unit operated at 85° C. and 15 barg, that was charged with a POMS siloxane membrane. The base oil product Cloud Point reduced to −3° C. The appearance of the heavy base oil permeate was Bright & Clear. Kinematic viscosity of the heavy base oil was low at 17 centistokes. Yield of heavy base oil basis catalytic dewaxing unit intake was low at 24% by weight. The various experimental data are shown in Table 1.

This example demonstrates that it is feasible to obtain bright and clear heavy base oil with one membrane step (not part of this patent application), however in that case significantly higher severity operation of the catalytic dewaxing unit is required at the expense of yield and viscosity of the potential heavy base oil material and consequently of yield and viscosity of the final haze free (bright and clear) heavy base oil product.

TABLE 1

| | | Yield | | | | | | | | | 2nd | |
|---|---|---|---|---|---|---|---|---|---|---|---|---|
| | Catalytic | of Hazy | Heavy | Heavy | Heavy | 1st | 1st | 2nd | 2nd | 2nd | membrane | |
| | dewaxing | Heavy | Base | Base | Base | mem- | mem- | mem- | membrane | membrane | Permeate | Appear- |
| | reactor | Base | Oil Kin. | Oil | Oil | brane | brane | brane | permeate | Permeate | Kin. | ance |
| | temper- | Oil on | Viscosity @ | Cloud | Pour | permeate | Cloud | permeate | Cloud | Pour | Viscosity @ | 2nd |
| | ature | intake | 100° C. | Point | Point | yield | Point | yield | Point | Point | 100° C. | membrane |
| | (° C.) | (% w) | (cSt) | (° C.) | (° C.) | (% wt) | (° C.) | (% wt) | (° C.) | (° C.) | (cSt) | permeate |
| Example 1 | 331 | 52.3 | 25.0 | 49.3 | −30 | 36.6 | 19.3 | 30.7 | −10.7 | −37.0 | 19.0 | Bright & |
| | | | | | | | | | | | | Clear |
| Example 2 | 336 | 40.1 | 23.0 | 38.4 | −53 | 32.1 | 8.4 | 28.2 | −21.6 | −57.0 | 17.0 | Bright & |
| | | | | | | | | | | | | Clear |
| Example 3 | 319 | 88.7 | 31.2 | 82.0 | 28 | 35.5 | 52.0 | 25.5 | 22.0 | 23.0 | 25.2 | Hazy |
| Example 4 | 340 | 28.0 | 20.9 | 27.5 | −70 | — | — | 23.8 | −2.5 | −75.0 | 16.9 | Bright & |
| | | | | | | | | | | | | Clear |

1. A process for preparing a base oil fraction having a reduced cloud point from a hydrocarbon feed which is derived from a Fischer-Tropsch process, the process comprises the steps of:
(a) providing a hydrocarbon feed which is derived from a Fischer-Tropsch process;
(b) subjecting the hydrocarbon feed of step (a) to a catalytic dewaxing treatment to obtain an at least partially isomerised product;
(c) separating at least part of the at least partially isomerised product as obtained in step (b) into one or more light hydrocarbon fractions and one or more heavy base oil fractions;
(d) separating at least one of the heavy base oil fractions as obtained in step (c) by means of a first membrane into a first permeate which comprises a base oil having a reduced cloud point and a first retentate which comprises a base oil containing haze compounds, wherein the membrane separation is carried out at a temperature in the range of from the pour point of the base oil and up to 120° C. and a pressure in the range of from 5-60 bar; and
(e) separating at least part of the first permeate as obtained in step (d) by means of a second membrane into a second permeate which comprises a base oil having a further reduced cloud point and a second retentate which comprises a base oil containing haze compounds, wherein the membrane separation is carried out at a temperature in the range of from the pour point of the base oil and up to 120° C. and a pressure in the range of from 5-60 bar; and
(f) recovering the second permeate as obtained in step (e).

2. A process according to claim 1, wherein the first membrane used in step (d) is a nano-filtration membrane or a reserve osmosis type membrane.

3. A process according to claim 1, wherein the second membrane used in step (e) is a nano-filtration membrane or a reserve osmosis type membrane.

4. A process according to claim 1, wherein the first and second membrane used in steps (d) and (e) comprise a top layer made of a dense membrane and a support layer of a porous membrane.

5. A process according to claim 4, wherein the dense membrane is made from a polysiloxane.

6. A process according to claim 1, wherein the separation in step (c) is carried out by distillation.

7. A process according to claim 1, wherein the catalytic dewaxing is carried out at a temperature in the range of from 200-500° C. and at a pressure in the range of from 10-200 bar, and in the presence of a dewaxing catalyst and hydrogen.

8. A process according to claim 7, wherein the dewaxing catalyst comprises a molecular sieve and a Group VIII metal, wherein the molecular sieve is selected from a group consisting of a MTW, MTT, TON type molecular sieve or ZSM-48 or EU-2.

9. A process according to claim 1, wherein the second permeate as obtained in step (e) has a cloud point of less than 30° C.

10. A process according to claim 1, wherein at least part of the first retentate as obtained in step (d) is recycled to step (b).

11. A process according to claim 1, wherein at least part of the second retentate as obtained in step (e) is recycled to step (b).
